(19) United States
(12) Patent Application Publication
(10) Pub. No.: US 2014/0114671 A1
(43) Pub. Date: Apr. 24, 2014

(54) MAPPING A CARE PLAN TEMPLATE TO A CASE MODEL

(71) Applicant: INTERNATIONAL BUSINESS MACHINES CORPORATION, Armonk, NY (US)

(72) Inventors: Jianying Hu, Bronx, NY (US); Geetika Tewari Lakshmanan, Winchester, MA (US); Jing Li, Beijing (CN); Jing Mei, Beijing (CN); Guo Tong Xie, Beijing (CN)

(73) Assignee: International Business Machines Corporation, Armonk, NY (US)

(21) Appl. No.: 13/655,918

(22) Filed: Oct. 19, 2012

(51) Int. Cl. G06Q 50/22

(52) U.S. Cl. CPC G06Q 50/22
USPC 705/2

(57) ABSTRACT

A method of mapping a care plan template to a case model includes receiving a care plan template, extracting elements from the care plan template, wherein the elements correspond to a phase comprising at least one task and data attributes corresponding to the task, mapping the task of the care plan template to a task of the case model, mapping a precedence relationship of the task of the care plan template to preconditions of the task of the case model, mapping the data attributes of the care plan template to properties of the case model, wherein the properties are associated with the task of the case model, mapping the task of the care plan template to a role of the case model, and generating the case model including the mapped task, the mapped precedence relationship, the mapped data attributes, and the mapped role.

### BACKGROUND

1. Technical Field

The present disclosure relates to the utilization of a process-aware information system (PAIS) in the medical care field, and more particularly, to a system and method for mapping a care plan description into a case model to be used in a case management system.

2. Discussion of Related Art

A care plan description, or a care plan template, is a set of guidelines created by a medical professional with the goal of treating patients having in different healthcare scenarios. For example, a medical professional having knowledge of congestive heart failure (CHF) may create a care plan description describing the tasks involved with treating patients having CHF. Tasks may include evaluating the condition of certain vital signs, performing diagnostic tests, and administering medications. A care plan template may be manually mapped to workflow models and services by experts. Manually mapping a care plan template to workflow models can be time consuming and expensive, since expert input is required to perform the mapping. Further, since the control flow in a workflow model is pre-determined and cannot be changed during runtime, workflow models representing care plan templates have limited flexibility and may not be suitable for healthcare applications where physicians, care managers and other entities may need to change the control flow of patient care during runtime based on exceptional conditions relating to a patient's health or external factors.

### BRIEF SUMMARY

According to an exemplary embodiment of the present invention, a method of mapping a care plan template to a case model of a process-aware information system (PAIS) includes receiving a care plan template, extracting elements from the care plan template, wherein the elements correspond to a phase of care comprising at least one task and data attributes corresponding to the at least one task, mapping the at least one task of the care plan template to at least one task of the case model, mapping a precedence relationship of the at least one task of the care plan template to preconditions of the at least one task of the case model, mapping the data attributes of the care plan template to properties of the case model, wherein the properties are associated with the at least one task of the case model, mapping the at least one task of the care plan template to a role of the case model, and generating the case model comprising the mapped task, the mapped precedence relationship, the mapped data attribute, and the mapped role.

According to an exemplary embodiment of the present invention, a case model mapping system includes a care plan extraction module and a mapping module. The care plan extraction module is configured to receive a care plan template from a care plan template database and extract elements from the care plan template, wherein the elements correspond to a phase of care including at least one task and data attributes corresponding to the at least one task. The mapping module is configured to map the at least one task of the care plan template to a task of the case model, map a precedence relationship of the at least one task of the care plan template to preconditions of the at least one task of the case model, map the data attributes of the care plan template to properties of the case model, wherein the properties are associated with the at least one task of the case model, map the at least one task of the care plan template to a role of the case model, and generate the case model comprising the mapped task, the mapped precedence relationship, the mapped data attributes, and the mapped role.

According to an exemplary embodiment of the present invention, a computer program product for mapping a care plan template to a case model of a process-aware information system (PAIS) includes a computer readable storage medium having program code embodied therewith, the program code executable by a processor, to perform a method including receiving a care plan template, extracting, by the processor, elements from the care plan template, wherein the elements correspond to a phase of care comprising at least one task and data attributes corresponding to the at least one task, mapping, by the processor, the at least one task of the care plan template to at least one task of the case model, mapping, by the processor, a precedence relationship of the at least one task of the care plan template to preconditions of the at least one task of the case model, mapping, by the processor, the data attributes of the care plan template to properties of the case model, wherein the properties are associated with the at least one task of the case model, mapping, by the processor, the at least one task of the care plan template to a role of the case model, and generating, by the processor, the case model comprising the mapped task, the mapped precedence relationship, the mapped data attributes, and the mapped role.

### BRIEF DESCRIPTION OF THE SEVERAL VIEWS OF THE DRAWINGS

The above and other features of the present invention will become more apparent by describing in detail exemplary embodiments thereof with reference to the accompanying drawings, in which:

FIG. 1 shows a case model mapping system, according to an exemplary embodiment of the present invention.

FIG. 2 is a system diagram showing an overview of a case model mapping system, according to an exemplary embodiment of the present invention.

FIG. 3 is a flowchart showing a method of mapping a care plan template to a case model, according to an exemplary embodiment of the present invention.

FIG. 4 shows an example of a care plan template and an exemplary phase of care of the care plan template, according to an exemplary embodiment of the present invention.

FIG. 5 shows an example of a case model, according to an exemplary embodiment of the present invention.

FIG. 6 shows an example of phases of care of a care plan template, and their associated tasks, to be mapped to a case model, according to an exemplary embodiment of the present invention.

FIGS. 7-8 show examples of mapping elements of care plan guidelines to a case model, according to an exemplary embodiment of the present invention.

FIG. 9 shows an example of phases of care of a care plan template, and the tasks associated with each phase, to be mapped to a case model, according to an exemplary embodiment of the present invention.

FIGS. 10A-10B show an example of task consolidation implemented during the mapping of a care plan template to a case model, according to an exemplary embodiment of the present invention.

FIG. 11 shows a computer system for performing a method of mapping a care plan template to a case model, according to an exemplary embodiment of the present invention.

### DETAILED DESCRIPTION

Exemplary embodiments of the present disclosure now will be described more fully hereinafter with reference to the accompanying drawings. This disclosure, may however, be embodied in many different forms and should not be construed as limited to embodiments set forth herein.

According to exemplary embodiments of the present disclosure, a case model may be created automatically based on care plan guidelines without requiring the manual entry of input from a medical expert. Once the case model is created, it can be instantiated and run for each individual patient. Physicians, nurses, care managers, nutritionists, and physician's assistants can interact with the case, accessing information, and editing information in the case while they interact with a patient.

In the following description, the terms plan description, care plan description, healthcare plan description, and care plan template may be used to refer to a medical plan created and used by healthcare professionals to assist in administering care to patients. The terms are synonymous and can be used interchangeably. A healthcare scenario can be modeled as a care plan description. For example, a care plan template for congestive heart failure (CHF) ambulatory patients corresponding to the patients' admittance to a hospital, discharge from a hospital, and treatment plan can be modeled as a care plan description by an expert having knowledge of CHF.

A care plan template includes various phases of care (e.g., Phase 1, Phase 2, Phase 3, etc.), each having certain tasks. The tasks may be associated with certain data attributes. Tasks may include, for example, taking the vital signs of a patient, measuring the height and/or weight of the patient, administering a medication to the patient, having the patient perform specific physical exercises, etc. Each phase of care may have a goal (e.g., an expected outcome), which can be evaluated at the end of each phase. The phases of care in a care plan template may adhere to a precedence relationship. For example, tasks included in Phase 3 of a care plan template may not be initiated until the completion of all tasks included in Phase 1 and Phase 2 of the care plan template. Phases of care may correspond to steps to be performed, and may be based on the condition of a specific patient, however, phases of care are not limited thereto. For example, admittance to, and discharge from a hospital may correspond to phases of care in a care plan template.

A physician's diagnosis may be implemented to determine which phase of a care plan template a particular patient instance belongs to. Further, if a care plan template includes any optional tasks, a physician's diagnosis may be implemented to determine which optional tasks should be selected for a specific patient instance. Once these determinations have been made, the patient instance executes all selected tasks and all phases of the care plan template.

Different actors may have different responsibilities for processes that are to be carried out during the duration of healthcare treatment corresponding to a care plan template. That is, different actors may perform different roles in a care plan template. These actors/roles may be explicitly provided in the care plan template, or may be indirectly provided based on the expertise required to execute different specified tasks in the care plan template. For example, it is implicit that a task involving specifying the diet of a patient is to be performed by a physician or nutritionist, a task involving monitoring the blood pressure of a patient is to be performed by a nurse, and a task involving specifying physical activities to be performed by a patient is to be performed by a trainer, a nurse, or a physiotherapist. Further, it is implicit that any tasks that require a diagnosis to be made, or a determination of whether progression between phases of care should occur, are to be performed by a physician, and any tasks that require blood work to be taken are to be performed by a nurse or lab technician.

A process-aware information system (PAIS) is a system designed to manage and execute processes involving people, applications, and/or information sources on the basis of process models. A PAIS may be used by a group of people to support communication, coordination, and collaboration. Exemplary instantiations of a PAIS include an advanced case management (ACM) system, a supply chain management (SCM) system, and a customer relationship management (CRM) system. That is, a case management system utilizing case models corresponding to care plan templates is a type of PAIS. A PAIS logs events that take place with respect to case instances, and offers operational support to users of such dynamic processes. Utilization of a case management system in the medical care field provides physicians and care managers with the flexibility to execute any task in any order, and to select and remove tasks during the handling of each individual patient case in a case model instance.

According to exemplary embodiments of the present invention, a care plan template can be mapped to a model within a PAIS. For example, when the PAIS is a case management system, a care plan template may be mapped to a case model to be utilized in the case management system. Mapping a care plan template to a model within a PAIS allows for the automatic mapping between a care plan template and a case model. Further, mapping a care plan template to a model within a PAIS allows for dynamic changes to control flow during execution, as well for the addition, definition, and execution of ad hoc tasks. For example, mapping a care plan template to a model within a PAIS according to exemplary embodiments of the present invention allows for changes in execution of the care plan template to be made during runtime, as the execution of the care plan template is not rigid and limited to a pre-determined implementation when mapped in the PAIS. Mapping a care plan template to a model within a PAIS results in a flexible reference model (e.g., the resulting case model based on a care plan template) that can accommodate all possibilities in the provisioning of care. For example, once care plan guidelines have been mapped to a case model in a case management system, the case model may be instantiated into individual care plan instances for different patients, and the control flow of each case model instance could be different. Control flow refers to the execution sequence of tasks.

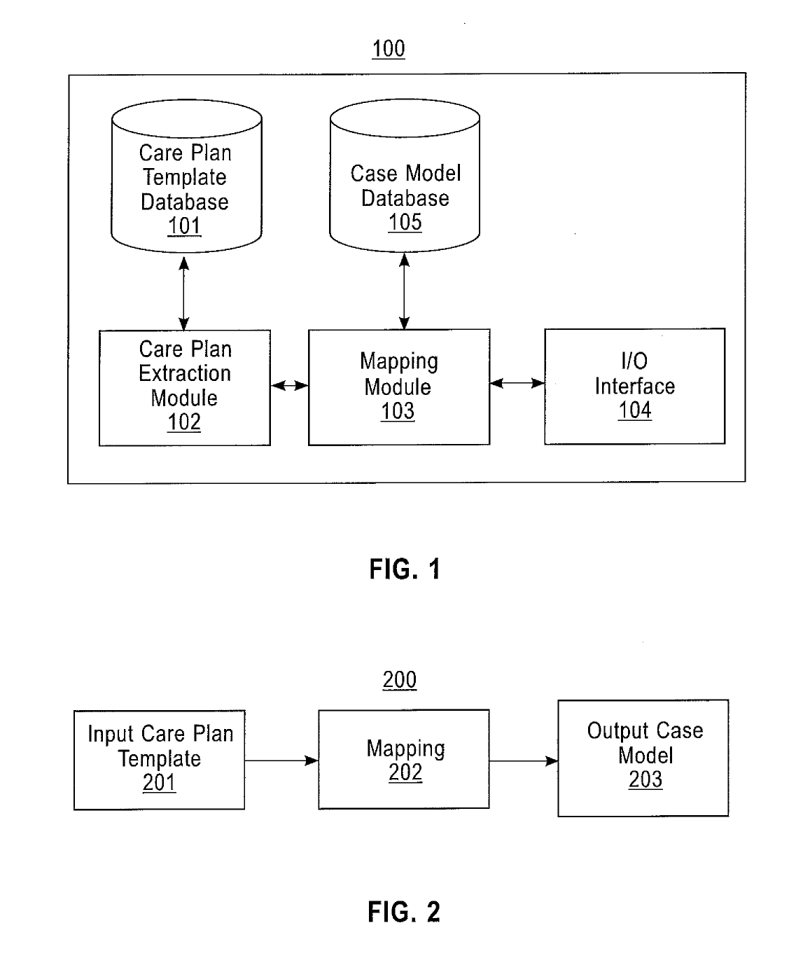

According to an exemplary embodiment, care plan templates may be embodied as data stored in a database. The elements included in a care plan template (e.g., phases of care, tasks, data attributes, etc.) may be extracted using, for example, ontologies and natural language processing (NLP) techniques. For example, referring to FIG. 1, a case model mapping system 100 according to an exemplary embodiment includes a care plan extraction module 102, a mapping module 103, and an I/O interface 104. The case model mapping system 100 may further include a care plan template database 101 and a case model database 105. Alternatively, the care plan template database 101 and/or the case model database 105 may be disposed separate from the case model mapping system 100, and the case model mapping system 100 may interface with the databases 101 and 105. The care plan extraction module 102 receives care plan templates from the care plan template database 101, and extracts elements of the care plan templates using, for example, ontologies and NLP techniques, as described in further detail below. A case model may be created by a mapping module 103, and stored in the case model database 105. Once extracted, elements of the care plan template may be mapped to the case model using the mapping module 103. The case model may be output via the input/output interface 104.

A case model in a case management system is a list of processes or steps that define interactions between actors/roles and a system to achieve a desired goal. According to an exemplary embodiment, a case model includes tasks and roles. Tasks may include required tasks and optional tasks, as well as automatic and manual tasks. Manual tasks are those which require a certain level of human interaction to be completed. Tasks may be members of certain task groups. A task of a case model may initiate a step flow, which consists of a sequence of steps having of a lower granularity than a task. The execution of a step flow may cause one or more case instance property values to change.

Once a case model has been created, individual case instances based on the case model can be instantiated. These individual case instances can then be handled by various actors (e.g., physicians, nurses, lab technicians, etc.) who enter data to drive the instances. In a case model, the included tasks may be implemented in any order, and may be executed as many times as necessary for a particular case instance. Execution of a task may cause the values of one or more properties of a case instance to change. In an exemplary embodiment, preconditions can be specified to generate an ordering of execution between tasks in a case instance. Preconditions may be triggered by case properties (e.g., data values that exist in the case model such as string values, boolean values, etc.).

As described above, a case model includes roles. Different roles specified in a case model have the ability to execute different tasks. For example, a case model may include three roles: a physician, a nurse, and a nutritionist. The roles correspond to actors responsible for handling the case model. The actors may use a case management tool to access parts of the case model corresponding to their respective roles. For example, a physician can access a case model, execute certain tasks, log new data findings, and initiate the execution of a care phase.

Utilizing a case model to map a care plan template, as performed in exemplary embodiments, allows a patient to begin at any phase of care of the care plan template. For example, different patients may begin at different phases of care based on the patients' individual conditions. Mapping to a case model further allows different patients to traverse different phases of care in different orders, and to repeat certain phases of care indefinitely based on the patients' individual conditions. Thus, mapping a care plan template to a case model results in a high degree of flexibility, and the ability to dynamically change execution flow. Mapping a care plan template to a case model allows for the utilization of data that may be collected from multiple sources, and results in execution that is highly data driven.

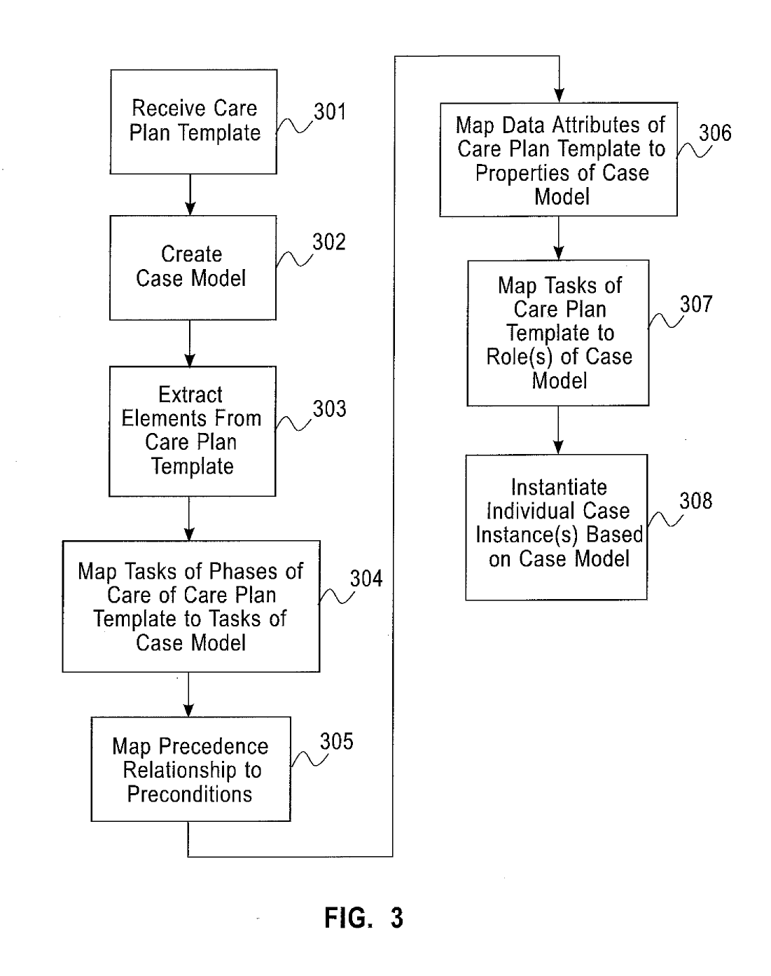

FIG. 2 is a system diagram showing an overview of a case model mapping system, according to an exemplary embodiment. As shown in FIG. 2, a case model mapping system 200 receives a care plan template(s) as input at block 201. As described above with reference to FIG. 1, the care plan template may be stored in, and retrieved from a care plan template database 101. The care plan includes a plurality of phases of care, each having certain tasks associated with certain data attributes. Data attributes may include requirements of a phase of care such as, for example, laboratory tests, diagnostic names, treatment names, intervention names, and attributes to monitor (e.g., crackles on lungs, heart rate, creatinine levels, etc.) At block 202, the care plan template is mapped to a case model. This mapping may be performed using multiple design options, as described below, and may be implemented by the mapping module 103 of FIG. 1. At block 203, a case model for use in a case management system is output. The outputted case model may be compatible with the Case Management Process Modeling (CMPM) 2010 system, which is an industry standard, however exemplary embodiments are not limited thereto. The outputted case model may include, for example, tasks, preconditions, properties (e.g., data attributes exchanged between tasks), and document metadata.

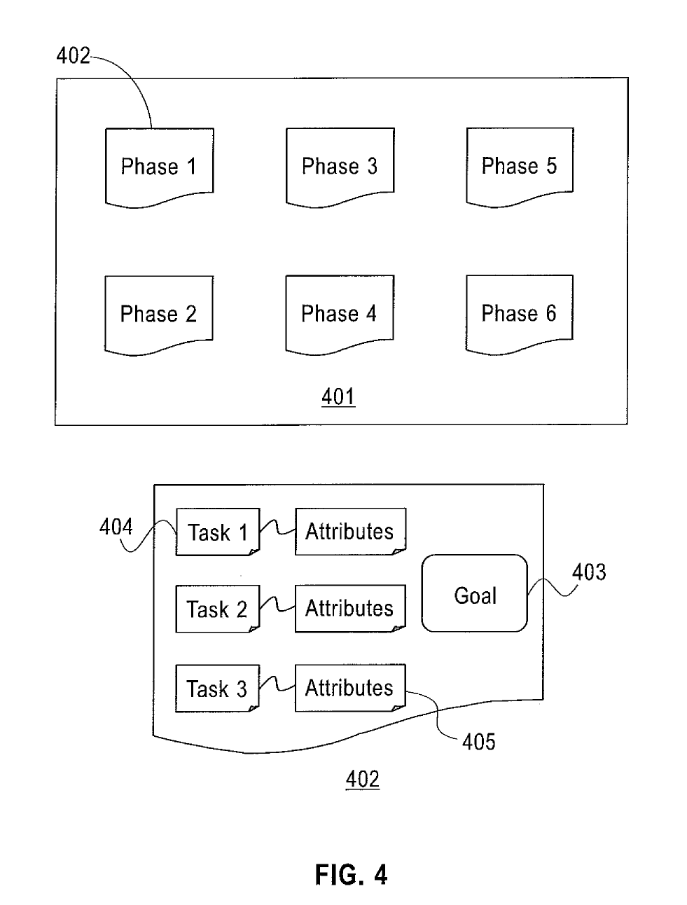

FIG. 3 illustrates a method of mapping a care plan template to a case model, according to an exemplary embodiment of the present invention.

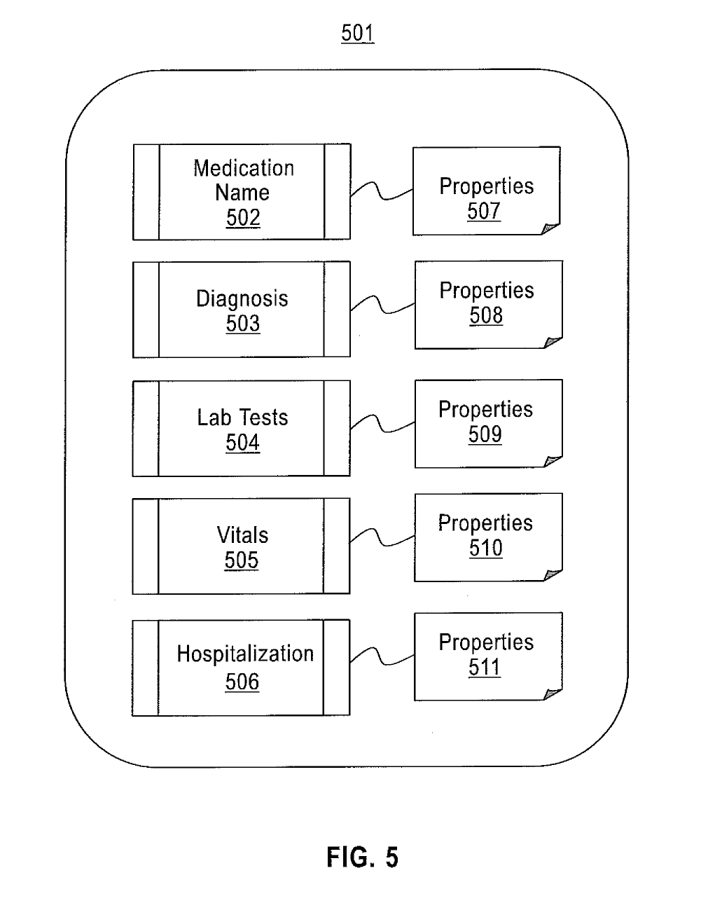

Referring to FIG. 3, according to an exemplary embodiment, a care plan template is received at block 301. An exemplary care plan template is shown in FIG. 4. As described above, the care plan template 401 includes phases of care 402, each including a goal 403 (e.g., an expected outcome), certain tasks 404 to be performed to achieve the goal, and data attributes 405 associated with each task 404. The care plan template 401 shown in FIG. 4 is exemplary, and is not limited to the number of phases of care 402, and tasks 404 and data attributes 405 shown in FIG. 4. The care plan template may be received from the care plan template database 101 of FIG. 1. A case model is created at block 302. The case model may be created by the mapping module 103 of FIG. 1, and stored in the case model database 105 of FIG. 1. Elements of the care plan template 401 are parsed and extracted from the care plan template 401 at block 303. As described above, ontologies and existing natural language processing (NLP) techniques may be used to extract elements from the care plan template 401. For example, using ontologies, intermediate level classification may be applied to avoid having an excessively large number of extracted elements. That is, classifier names based on categories or subclasses may be utilized. The extracted elements are utilized to map tasks 404 of phases of care 402 of the care plan template 401 to tasks of a case model at block 304. Extracted elements may include, for example, lab names, diagnostic names, treatment names, intervention names, attributes to monitor (e.g., crackles on lungs, heart rate, creatinine levels, etc.), vitals, medication names, etc.

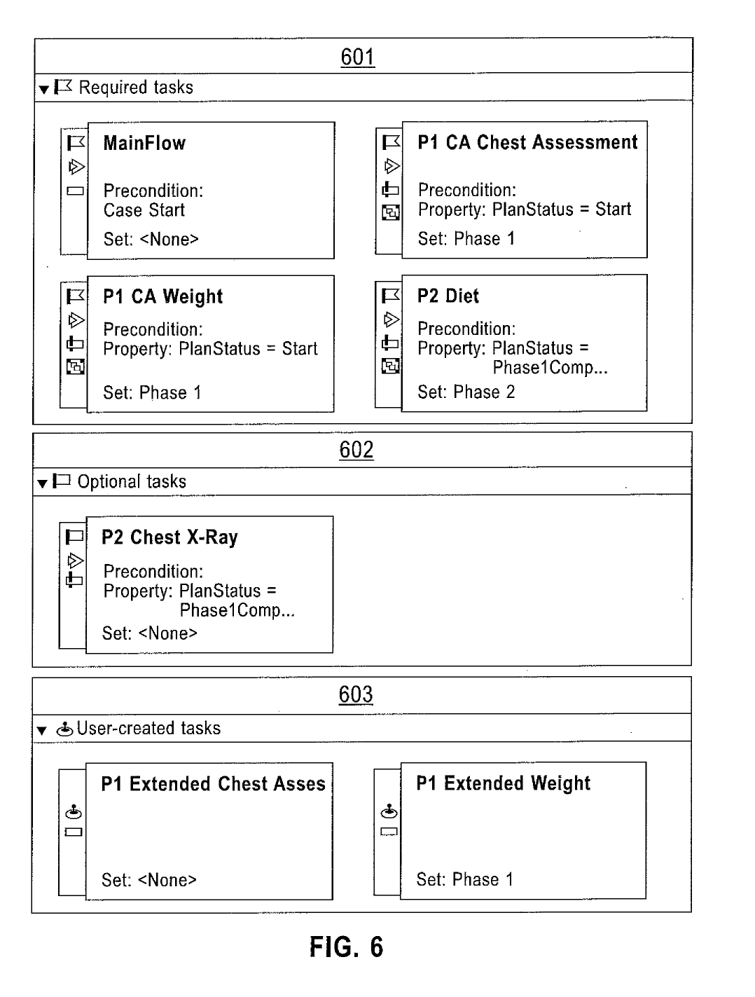

Since ontologies and/or natural language processing (NLP) techniques may be utilized, the names of tasks created in the case model may not actually be present in the care plan template 401. For example, a case model 501 for CHF ambulatory care patients based on a CHF care plan template may include the tasks shown in FIG. 5. Tasks may include, for example, a Medication Name 502 (e.g., Diuretics, Antianginal Agents, Cardiotonics, Beta Blockers, etc.), a Diagnosis 503 (e.g., Hypertensive Heart Disease, Cardiomyopathy, Heart Failure, etc.), Lab Tests 504 (e.g., Albumin, Alkaline Phosphatase, Bilirubin, ALT, AST, Creatinine, Digoxin, etc.), Vitals 505, and Hospitalization 506. Tasks 502 to 506 may be derived from and grouped based on various different tasks 404 of the care plan template 401 using NLP techniques and/or ontologies. The case model 501 may include several tasks corresponding to each type of task. For example, the case model 501 may include one or more Medication Name tasks 502, Diagnosis Tasks 503, Lab Tests tasks 504, Vitals tasks 505, and/or Hospitalization tasks 506.

The precedence relationship between tasks associated with phases of care 402 in the care plan template 401 are mapped to preconditions of the tasks 502-506 of the case model 501 at block 305. For example, during execution, tasks in a particular phase number may not be executed before tasks in all previous phase numbers have completed (e.g., tasks in Phase 3 are not executed before tasks in Phases 1 and 2 have completed), assuming the patient started in phase 1 of care and improved to phase 2 and then to phase 3 of care. For example, a tolerance activity level≧3 may be tolerated. In addition, tasks in a phase of care may not be executed simultaneously with tasks in another phase of care for the same patient, since a patient is associated with one single phase of care at a time.

At block 306, the data attributes 405 corresponding to the tasks 404 of the care plan template 401 are mapped to properties 507-511 in the case model 501. Properties 507-511 may be included in documents having metadata. Each task has associated properties (e.g., each task may be associated with, and linked to a document). For example, a Medication Name task 502 corresponding to Diuretics may be associated with a Diuretics_Doc having properties such as, for example, dosage, date prescribed, number of refills, etc. A Diagnosis task 503 corresponding to Heart Failure may be associated with a HeartFailure_Doc having properties such as, for example, diagnosis date. A Lab Tests task 504 corresponding to Bilirubin Direct may be associated with a BilimbinDirect_Doc having properties such as, for example, lab date, lab result, lab result date, etc. A Vitals task 505 may be associated with a Vitals_Doc having properties such as, for example, temperature, blood pressure, pulse, weight, height, etc.

The types of properties of each type of task in the case model are similar. For example, all Medication Name tasks 502 of the case model 501 will have similar associated types of properties 507, all Diagnosis tasks 503 of the case model 501 will have similar associated types of properties 508, all Lab Tests tasks 504 of the case model 501 will have similar associated types of properties 509, all Vitals tasks 505 of the case model 501 will have similar associated types of properties 510, and all Hospitalization tasks 506 of the case model 501 will have similar associated types of properties 511. The types of properties may include, for example, string values, boolean values, integer values, etc.

At block 307, tasks 404 of the care plan template 401 are mapped to a role(s) of the case model 501, as described above.

The case model 501 shown in FIG. 5 is exemplary, and is not limited to the number and type of tasks 502-506 and properties 507-511 shown in FIG. 5.

Once tasks 404 of the phases of care 402 of the care plan template 401 have been mapped to tasks 502-506 of the case model 501, and data attributes 405 of the care plan template 401 have been mapped to properties 507-511 of the case model 501, individual case instances may be instantiated based on the case model 501 at block 308.

When the tasks 404 of the phases of care 402 are mapped to tasks 502-506 of the case model 501, one or more step flows are invoked by the task 502-506 at the case model 501. Exemplary embodiments may utilize different approaches during this mapping procedure, as described in further detail below.

According to exemplary embodiments, the elements of a care plan template may be mapped to a case model using a variety of design patterns, as described in more detail below. The design pattern to be implemented may be selected by a user. For example, referring to FIG. 1, a mapping design indicator may be received as input (e.g., from the user) by the I/O interface 104. The mapping design indicator indicates the mapping design to be implemented during the mapping of the care plan template 401 to the case model 501.

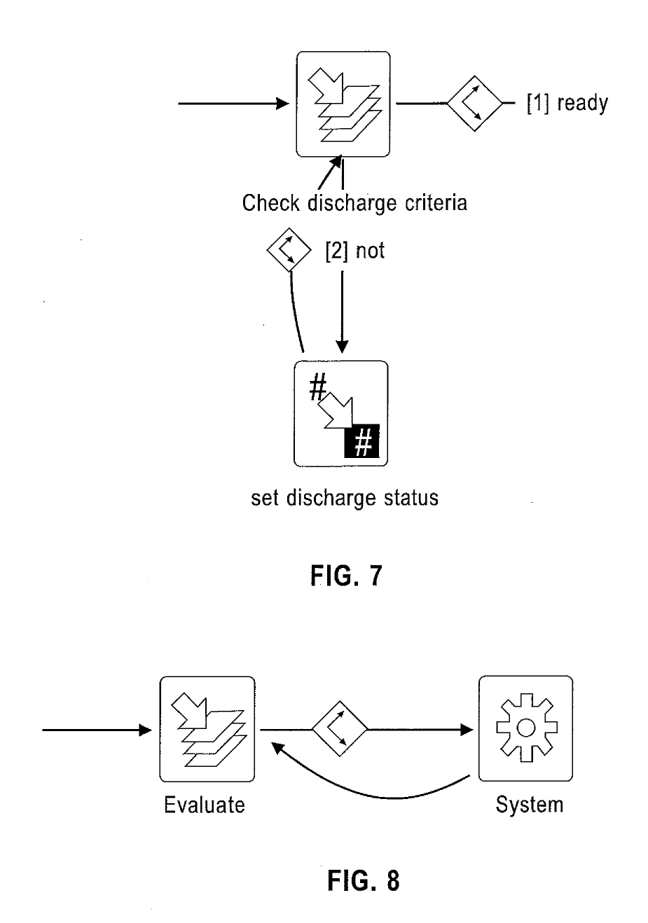

In an exemplary embodiment, a care plan template may be mapped to a case model, and some tasks having a small number of steps may utilize a workflow within the case model, resulting in a flexible implementation. A phase of care of a care plan template may include three types of tasks: required tasks 601, optional tasks 602, and user-created tasks (e.g., ad hoc tasks) 603, as shown in FIG. 6. Utilization of three types of tasks results in mapping tasks of the care plan template to fewer tasks in the case model. Each task in the case model invokes a small, rigid workflow upon execution.

FIG. 6 shows a phase of care of a care plan template for a CHF patient. Referring to FIG. 6, the required tasks 601 include a mainflow task that controls the phase process, and several additional required care activities (e.g., activities relating to a patient's weight, chest assessment, and diet). The optional tasks 602 include optional care activities (e.g., a care activity involving taking an x-ray of a patient's chest). The optional tasks 602 may be manually started by a user (e.g., a case user), and may not be repeatable. The user-created tasks 603 include care activities specified by the user (e.g., care activities relating to extended chest assessment and extended weight). The user-created tasks 603 may be repeatable care activities, and may be manually added by a user on an ad hoc basis. Utilization of required tasks 601, optional tasks 602, and user-created tasks 603 results in a flexible case model that may execute small steps in a workflow. For example, when a certain task is being executed, that task may invoke a workflow, the workflow may be executed, and upon completion of the workflow, execution of other tasks and phases of care of the case model may continue.

The phases of care of a care plan template may be mapped to an inclusive set of the case model. For example:

<sdf: taskGroup>

<sdf:id>1</sdf:id>
<sdf:name>Phase I</sdf:name>
<sdf:groupMode>inclusive</sdf:groupMode>

</sdf:taskGroup>

As described above, each phase of care includes a goal (e.g., an expected outcome). The outcome at the end of each phase of care can be evaluated to ensure that the expected outcome has been achieved. When executing the case model corresponding to the care plan template, execution of the next phase of care may not be commenced until the expected outcome of the previously executed phase of care has been achieved. The goal, or expected outcome may be mapped to case properties of the case model. For example, in a phase of care of a care plan template for a CHF patient, the goal, or expected outcome of a patient, may be the absence of chest pain. That is, a phase of care may not be deemed to have been completed until the patient is no longer experiencing chest pain. The physician or another actor with proper authority makes the decision as to whether a phase of care is complete. For example:

<sdf:propertyBooleanDefinition>

<cmis:id>{1D0EA4C9-8459-44CA-8057-B2778467AF51}</cmis:id>
<cmis:localName>CHF1_P1Outcome_absenceOfChestPain</cmis:localName>
<cmis:displayName>P1Outcome_absenceOfChestPain</cmis:displayName>
<cmis:description>ABSENCE OF CHEST PAIN</cmis:description>
<cmis:propertyType>boolean</cmis:propertyType>
<cmis:cardinality>single</cmis:cardinality>
<cmis:updatability>readwrite</cmis:updatability>
<cmis:inherited>false</cmis:inherited>
<cmis:required>false</cmis:required>
<cmis:queryable>true</cmis:queryable>
<cmis:orderable>true</cmis:orderable>
<cmis:openChoice>false</cmis:openChoice>
<cmis:defaultValue/>

The actors/roles of a care plan template may be mapped to actors/roles of the case model. The tasks of a care plan template may be mapped to tasks of the case model. For example:

<sdf:task>

<sdf:id>{9EA9DC26-74A3-4F0A-A81E-DBA454BE6ABA}</sdf:id>
<sdf:name>CHF1_P1CAWeight</sdf:name>
<sdf:displayName>Phase 1 Daily Weight</sdf:displayName>
<sdf:description>daily weight discuss with patient - documented by nurse and
patient</sdf:description>
<sdf:propertyPrecondition>CHF1_PlanStatus = 1</sdf:propertyPrecondition>
<sdf:required>false</sdf:required>
<sdf:launchMode>automatic</sdf:launchMode>
<sdf:repeatable>false</sdf:repeatable>
<sdf:userCreatable>false</sdf:userCreatable>
<sdf:editable>true</sdf:editable>
<sdf:workflowName>CHF1_P1CAWeight</sdf:workflowName>
<sdf:groupId>1</sdf:groupID>

</sdf:task>

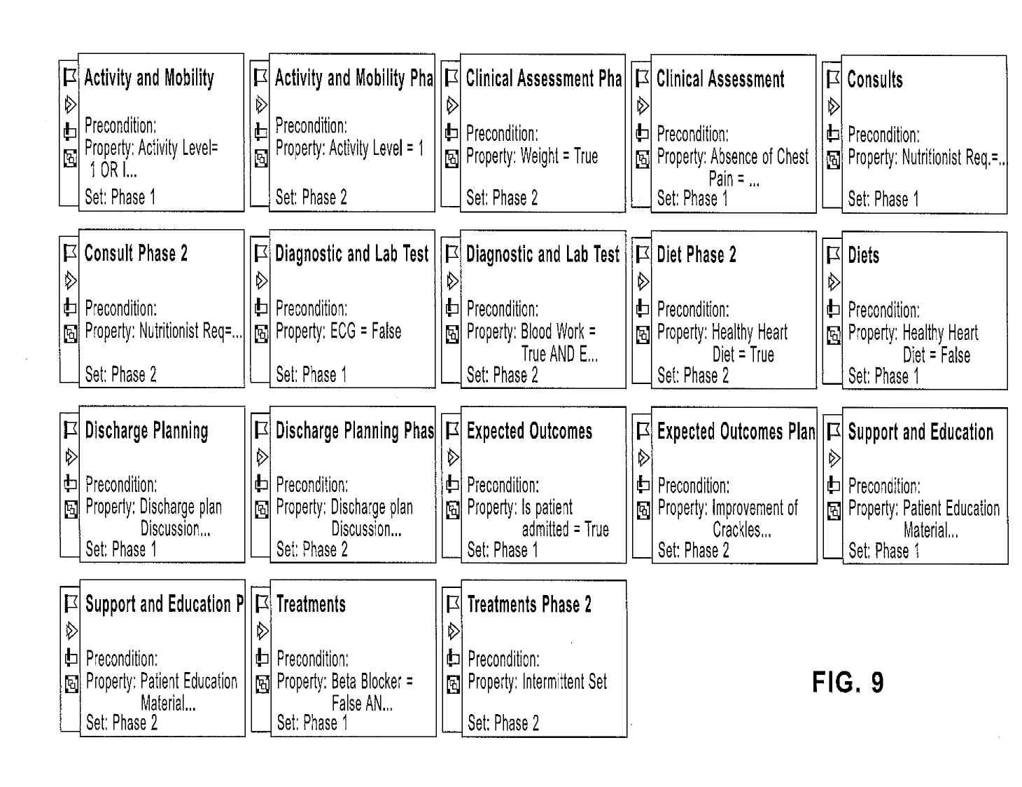

Attached documents from the care plan template may be mapped to a Solution (e.g., document type) of the case model, and data attributes (e.g., patient information) of the care plan template may be mapped to case properties of the case model in a similar manner as the goal, or expected outcome. An evaluation of the care plan template may be mapped to a flow step/case properties of the case model (see FIG. 7).

A sequence transition between phases of care (e.g., Phase-Phase) of the care plan template, and between tasks (e.g., Task-Task) of the care plan template may be mapped to preconditions of case tasks, and the values can be set within the mainflow task of the case model. For example:

<sdf:propertyPrecondition>CHF1_PlanStatus=1<sdf:propertyPrecondition>

A sequence transition between phases of care and tasks (e.g., Phase-Task) of the care plan template may be mapped to a sequence transition within the mainflow task of the case model. For example:

<Transition Id=”Workflow0.Map9.route0” Name=”” From=
“Workflow0.Map9.mapnode0” To=”Workflow0.Map9.mapnode1”>

A parallel transition between phases of care and tasks (e.g., Phase-Task) of the care plan template may be mapped to a parallel transition in the mainflow task of the case model. For example:

<TransitionRestrictions>

<TransitionRestriction>|

<Join Type=”XOR” />
<Split Type=”AND” />

</TransitionRestriction>

</TransitionRestrictions>

A parallel transition between tasks (e.g., Task-Task) of the care plan template may be directly supported in the case model.

Repeatable tasks of the care plan template may be mapped to user-created tasks of the case model. For example:

<sdf:task>

<sdf:id>{3D458E81-A92A-4E1C-BDDD-D9D76AAB5FE2}</sdf:id>
<sdf:name>CCP_P1ExtendedECG</sdf:name>
<sdf:displayName>P1 Extended Weight</sdf:displayName>
<sdf:required>true</sdf:required>
<sdf:launchMode>automatic</sdf:launchMode>
<sdf:repeatable>false</sdf:repeatable>
<sdf:userCreatable>true</sdf:userCreatable>
<sdf:editable>true</sdf:editable>
<sdf:workflowName>CCP_P1ExtendedECG</sdf:workflowName>

</sdf:task>

The frequency within a care plan template may be mapped to a flow design pattern of the case model (see FIG. 8). Optional tasks of the care plan template may be mapped to manual tasks of the case model.

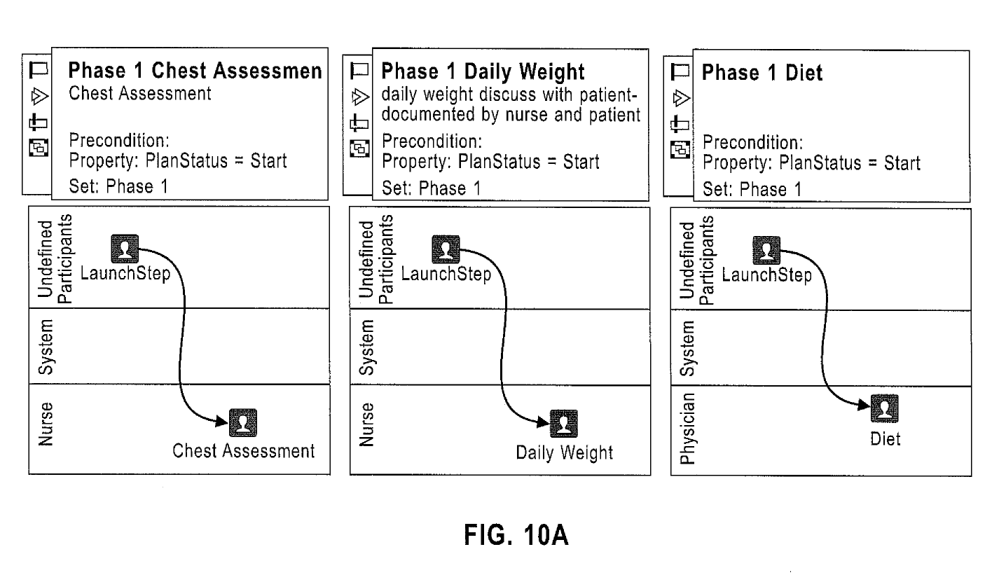

In an exemplary embodiment, a care plan template may be mapped to a case model, and workflows may not be utilized in the case model. For example, all tasks of a care plan template may be mapped to high-level tasks having no precedence in the case model, resulting in a highly flexible implementation. For example, tasks may include required tasks and optional tasks (see FIG. 9), and tasks may be started manually or automatically. Any existing preconditions corresponding to a task must be satisfied before execution may be continued. Property values are read and written by each task, and represent data attributes of tasks. When the care plan template includes multiple phases of care, the sequential nature of tasks in each phase may be enabled via property preconditions relating to the tasks.

The mapping between a care plan template and a case model that does not utilize workflows may be similar to the mapping between a care plan template and a case model that utilizes a workflow for tasks having a small number of steps. For example, as described above, the phases of care of a care plan template may be mapped to an inclusive set of the ease model, the goal, or expected outcome may be mapped to case properties of the case model, the actors/roles of a care plan template may be mapped to actors/roles of the case model, the tasks of a care plan template may be mapped to tasks of the case model, attached documents from the care plan template may be mapped to a Solution (e.g., document type) of the case model, data attributes (e.g., patient information) of the care plan template may be mapped to case properties of the case model, repeatable tasks of the care plan template may be mapped to user-created tasks of the case model, and optional tasks of the care plan template may be mapped to manual tasks of the case model. In addition, an evaluation included in a care plan template may be mapped to a case task of a case model (e.g. Task=“Expected Outcome”). Sequence transitions between phases of care (e.g., Phase-Phase) of the care plan template, phases of care and tasks (e.g., Phase-Task) of the care plan template, tasks (e.g., Task-Task) of the care plan template, and parallel transitions between phases of care and tasks (e.g., Phase-Task) of the care plan template and tasks (e.g., Task-Task) of the care plan template) may be mapped to a flow route of the case model. For example:

<sdf:propertyPrecondition>CHF1_is XrayDone=true</sdf:propertyPrecondition>
The frequency within a care plan template may not be directly supported via mapping to the case model.

In an exemplary embodiment, performance may be improved via task consolidation. For example, when elements of a care plan template are mapped to a case model and some tasks include a small number of steps utilizing a workflow, and when elements of a care plan template are mapped to a case model and workflows are not utilized, multiple tasks may be consolidated into a single task. Tasks may be consolidated based on the starting mode of the tasks (e.g., automatic, manual, or user-created), whether the tasks are required or optional, whether the tasks are part of the same group (e.g., have the same set name), whether the tasks have the same precondition (e.g., the same document, or the same property condition), or for user-created tasks, the properties settings of a launch step. The name and description of tasks, the list of attachments of tasks, and workflows invoked by the tasks may be consolidated. When executed, consolidated tasks may be started or added using a batch process. When manually starting user-created tasks, the actual use scenarios may be considered for the granularity of the result task.

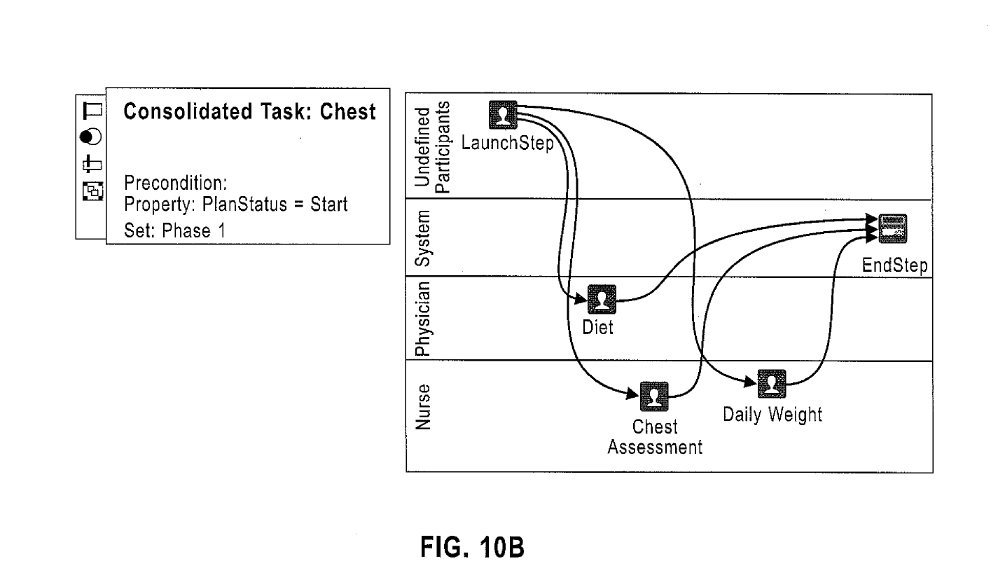

FIGS. 10A-10S shows an example of task consolidation, according to an exemplary embodiment. As shown in FIG. 10A, Phase 1 of a care plan template includes a Chest Assessment task, Daily Weight task, and Diet task. These tasks may be consolidated into a single Chest task of the case model, as shown in FIG. 10B.

It is to be understood that exemplary embodiments of the present invention may be implemented in various forms of hardware, software, firmware, special purpose processors, or a combination thereof. In one embodiment, a method for mapping a care plan template to a case model may be implemented in software as an application program tangibly embodied on a computer readable storage medium or computer program product. As such the application program is embodied on a non-transitory tangible media. The application program may be uploaded to, and executed by, a processor comprising any suitable architecture.

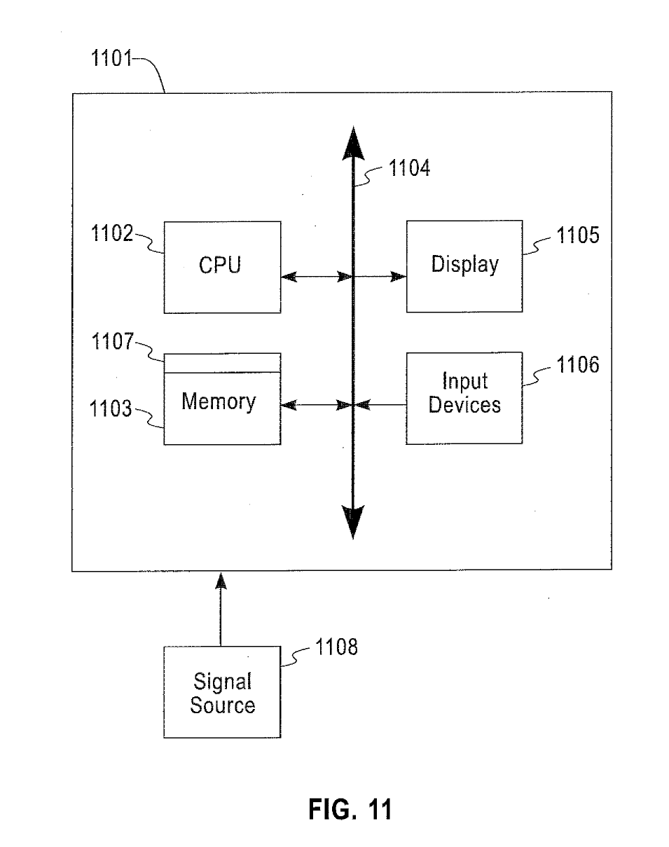

Referring to FIG. 11, according to an exemplary embodiment of the present invention, a computer system 1101 for mapping a care plan template to a case model can comprise, inter alia, a central processing unit (CPU) 1102, a memory 1103 and an input/output (I/O) interface 1104. The computer system 1101 is generally coupled through the I/O interface 1104 to a display 1105 and various input devices 1106 such as a mouse and keyboard. The support circuits can include circuits such as cache, power supplies, clock circuits, and a communications bus. The memory 1103 can include random access memory (RAM), read only memory (ROM), disk drive, tape drive, etc., or a combination thereof. The present invention can be implemented as a routine 1107 that is stored in memory 1103 and executed by the CPU 1102 to process the signal from the signal source 1108. As such, the computer system 1101 is a general-purpose computer system that becomes a specific purpose computer system when executing the routine 1107 of the present invention.

The computer platform 1101 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described exemplary embodiments for mapping a care plan template to a case model, it is noted that modifications and variations can be made by persons skilled in the art in light of the above teachings. It is therefore to be understood that changes may be made in exemplary embodiments of the disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A method of mapping a care plan template to a case model of a process-aware information system (PAIS), comprising:
receiving a care plan template;
extracting elements from the care plan template, wherein the elements correspond to a phase of care comprising at least one task and data attributes corresponding to the at least one task;
mapping the at least one task of the care plan template to at least one task of the case model;
mapping a precedence relationship of the at least one task of the care plan template to preconditions of the at least one task of the case model;
mapping the data attributes of the care plan template to properties of the case model, wherein the properties are associated with the at least one task of the case model;
mapping the at least one task of the care plan template to a role of the case model; and
generating the case model comprising the mapped task, the mapped precedence relationship, the mapped data attributes, and the mapped role.

2. The method of claim 1, wherein the PATS is a case management system.

3. The method of claim 1, further comprising:
receiving a mapping design indicator indicating a mapping design to be implemented during the mapping of the care plan template to the case model.

4. The method of claim 3, wherein the at least one task of the case model is one of a plurality of tasks of the case model, and each of the plurality of tasks invokes a workflow upon execution in response to the mapping design indicator.

5. The method of claim 3, wherein the task of the case model is one of a plurality of tasks of the case model, and each of the plurality of tasks does not invoke a workflow upon execution in response to the mapping design indicator.

6. The method of claim 3, wherein the at least one task of the care plan template is one of a plurality of tasks of the care plan template, and at least two of the plurality of tasks of the care plan template are mapped to a single task of the case model in response to the mapping design indicator.

7. The method of claim 1, wherein the at least one task of the care plan template is mapped to one of a required task of the case model, an optional task of the case model, or an ad hoc task of the case model.

8. The method of claim 1, wherein the at least one task of the care plan template is mapped to one of an automatic task of the case model or a manual task of the case model.

9. The method of claim 1, further comprising:
generating a document corresponding to the at least one task of the case model, wherein the properties of the case model are embodied as metadata in the document; and
linking the document to the at least one task of the case model.

10. The method of claim 1, wherein the extracted elements comprise at least one of lab names, diagnostic names, treatment names, intervention names, attributes to monitor, patient vitals, or medication names.

11. The method of claim 1, wherein extracting the elements from the care plan template is based on one of ontologies and natural language processing (NLP) techniques.

12. The method of claim 1, wherein the at least one task of the case model comprises a name different from a name of the at least one task of the care plan template.

13. The method of claim 1, wherein the at least one task of the case model corresponds to a medication name, and the properties of the case model comprise at least one of a dosage amount of a medication, a prescription date of the medication, or a number of remaining refills of the medication.

14. The method of claim 1, wherein the at least one task of the case model corresponds to a diagnosis, and the properties of the case model comprise a diagnosis date.

15. The method of claim 1, wherein the at least one task of the case model corresponds to a lab test, and the properties of the case model comprise at least one of lab data, a lab result, or a lab result date.

16. The method of claim 1, wherein the at least one task of the case model corresponds to vitals of a patient, and the properties of the case model comprise at least one of a temperature of the patient, blood pressure of the patient, a pulse of the patient, a weight of the patient, or a height of the patient.

17. The method of claim 1, wherein the care plan template is received from a care plan template database.

18. The method of claim 1, further comprising storing the case model in a case model database.
